(19) United States
(12) Patent Application Publication
(10) Pub. No.: US 2014/0111418 A1
(43) Pub. Date: Apr. 24, 2014

(54) METHOD FOR RECOGNIZING USER CONTEXT USING MULTIMODAL SENSORS

(71) Applicants: Sung-Young LEE, Seongnam-si (KR); Man-Hyung HAN, Yongin-si (KR); Young-Tack PARK, Seoul (KR)

(72) Inventors: Sung-Young LEE, Seongnam-si (KR); Man-Hyung HAN, Yongin-si (KR); Young-Tack PARK, Seoul (KR)

(73) Assignees: Soongsil University Research Consortium techno-PARK, Seoul (KR); University-Industry Cooperation Group of Kyung Hee University, Yongin-si (KR)

(21) Appl. No.: 13/905,796

(22) Filed: May 30, 2013

(30) Foreign Application Priority Data
Oct. 19, 2012 (KR) 10-2012-0116948

(51) Int. Cl. G06F 3/03

(52) U.S. Cl. CPC G06F 3/03
USPC 345/156

(57) ABSTRACT

There is provided a method for recognizing a user context using multimodal sensors, and the method includes classifying accelerometer data by extracting candidates for movement feature from the accelerometer data collected from an accelerometer, selecting one or more movement features from the extracted candidates for movement feature based on relevance and redundancy thereof, and then inferring a user's movement type based on the selected movement features using a first time-series probability model; classifying audio data by extracting surrounding features from the audio data collected from an audio sensor and inferring the user's surrounding type based on the extracted surrounding features; and recognizing a user context by recognizing the user context based on either of the movement type or the surrounding type.

### CROSS-REFERENCE TO RELATED APPLICATION

This application claims the benefit under 35 U.S.C. §119(a) of Korean Patent Application No. 10-2012-0116948, filed on Oct. 19, 2012, the entire disclosure of which is incorporated herein by reference for all purposes.

### BACKGROUND

1. Field

The following description relates to a method for recognizing context, and more specifically, a method for recognizing a user context using data collected from multimodal sensors of a mobile device.

2. Description of the Related Art

A smart phone and other mobile devices have built-in sensors, such as an accelerometer, a light sensor, a magnetic sensor, a gyroscope, a GPS receiver and a Wi-Fi module. Such sensors are used to recognize a user's activity and context. Since context recognition system is now being utilized in various aspects of daily life, as well as in many industries, it has garnered great interest from mobile device and application developers.

Conventional context recognition methods make use of a single sensor. Among various sensors, an accelerometer is known for efficiency in user context recognition. In 2010, A. Kahn and others proposed a method for recognizing a user's movement using an accelerometer. In addition, A. Eronen and others suggested, in 2006, a method for recognizing sound environment using an audio sensor. However, such conventional methods simply utilize a single sensor, rather than a combination of sensors, so that accuracy in recognizing a user context may not be good enough.

Meanwhile, S. Preece and others set forth, in 2009, a plurality of solutions about acceleration classification using a different feature extraction technique and a different classification algorithm. In this case, the feature selection algorithm is used to select the best features from entire features, rather than extracting features from predetermined ones using the feature extraction technique. In addition, the above method does not guarantee high accuracy in recognizing a user context, and is hardly employed in a mobile terminal due to the burden of calculating the entire features.

### SUMMARY

The following description relates to a method for recognizing user context based on data collected from multimodal sensors, such as an accelerometer and an audio sensor, which are is embedded in a mobile device to recognize various user contexts.

In addition, the following description offers a new feature extraction method for selecting superior features from features extracted from accelerometer data, thereby enhancing accuracy in recognizing a user context.

Furthermore, the present invention suggests a method for checking validity of a recognized user context using data collected from another sensor, thereby enhancing accuracy in recognizing a user context.

In one general aspect of the present invention, there is provided a method for recognizing a user context using multimodal sensors, and the method includes classifying accelerometer data by extracting candidates for movement feature from the accelerometer data collected from an accelerometer, selecting one or more movement features from the extracted candidates for movement feature based on relevance and redundancy thereof, and then inferring a user's movement type based on the selected movement features using a first time-series probability model; classifying audio data by extracting surrounding features from the audio data collected from an audio sensor and inferring the user's surrounding type based on the extracted surrounding features; and recognizing a user context by recognizing the user context based on either of the movement type or the surrounding type.

Each of the accelerometer and the audio sensor may activate only in a predetermined condition to collect the accelerometer data and the audio data, respectively.

The method may further include acquiring the user's movement speed information and location information from data collected from a GPS module and then checking validity of the recognized user context based on the movement speed information and the location information.
The method may further include acquiring WiFi access information from data collected from a WiFi module and then checking validity of the recognized user context based on is the WiFi access information.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flow chart illustrating a method for recognizing user context using multimodal sensors according to an exemplary embodiment of the present invention; and

FIG. 2 is a flow chart illustrating a method for selecting features to recognize user context according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions is of well-known functions and constructions may be omitted for increased clarity and conciseness.

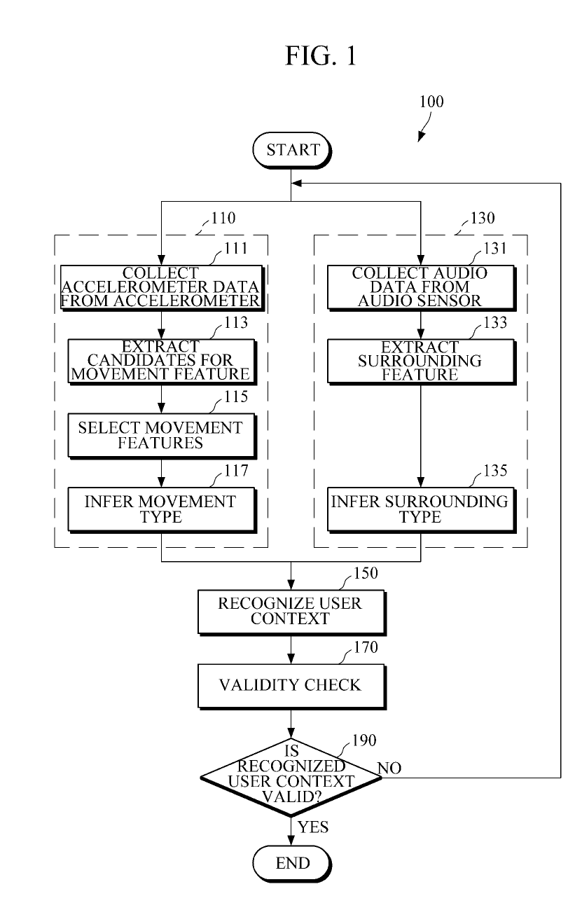

FIG. 1 is a flow chart illustrating a method for recognizing a user context using multimodal sensors.

Referring to FIG. 1, a method for recognizing a user context using multimodal sensors includes an operation for accelerometer classification 110, an operation for audio classification S130, an operation for user context recognition 150 and an operation for validity check 170.

In regard with the operation for accelerometer classification 110, accelerometer data is collected from an accelerometer in 111. Such an accelerator may include a mobile phone, a Personal Digital Assistant (PDA), a smart phone, a wristop computer, a wrist watch computer, a music player, a multimedia viewer and other built-in sensors of a mobile device. As a user carries out a mobile device on his body, accelerometer data collected from an accelerometer corresponds to the user's movement. Desirably, a 2-axis accelerometer is utilized and sensitivity of each axis is between −2g and 2g. In addition, accelerometer data is desirably collected at a frequency greater than 10 Hz. That is, it is desirable to collect the accelerometer data more than ten times per second.

Next, candidates for movement feature are extracted from the accelerometer data collected from the accelerometer in 113. Here, a plurality of candidates for movement feature may be extracted using various feature extracting techniques, rather than a single feature extracting technique. The extracted candidates for movement feature may include time donation feature, frequency domain feature and linear predictive coding feature.

Next, among the extracted candidates for movement feature, superior movement feature are selected in 115. In order to select the superior movement features among a plurality of movement feature candidates, a new method for selecting a movement feature may be employed. The method for selecting a movement feature will be provided later. By selecting the superior is movement features among the extracted movement feature candidates, user's movement type may be predicted with great accuracy. In addition, classifying the accelerometer data based on the selected movement features may improve efficiency in terms of calculation and memory.

Next, a user's movement type is inferred based on the selected movement features in 117. Here, the user's movement type is inferred using a time-series probability model, and the inferring process is repetitively performed at predetermined intervals. For example, a time-series probability model is used to infer a user's movement type based on three seconds of accelerometer data, and the inferring process is repetitively performed every three second. Here, a ‘movement type’ refers to a user's movement that has been recognized for a relatively short given time. For example, the user's movement type may include ambulatory activities, such as sitting, being still, walking and running, and transportation activities, such as a bus and a subway. The time-series probability model for classifying accelerometer data may include Gaussian Mixture Model (GMM), Hidden Markov Model (HMM), Dynamic Bayesian Network (DBN), Markov Random Field (MRF) and Conditional Random Field (CRF).

In addition, with respect to the operation for audio classification S130, audio data is collected from an audio sensor in 131. The audio sensor may be a built-in sensor of a mobile device, as the accelerator does. As a user carries the mobile device on his or her body, the audio data collected from the audio sensor is data corresponding sound in the surroundings of the user.

Next, surrounding features are extracted from the audio data collected from the audio sensor in 133. Here, various feature extracting techniques, rather than a single technique, may be used to extract such surrounding features. The feature extracting technique may be Mel Frequency Cepstral Coefficients (MFCCs), but aspects of the present invention are not limited thereto.

Next, a user's surrounding type is inferred based on the selected surrounding features 135. Specifically, the user's surrounding type is inferred using a time-series probability model, and the inferring process is repetitively performed at predetermined intervals. For example, a user's surrounding type is inferred using a time series probability model based on audio data which is collected every three second, and such inferring process is performed every three second. In this way, a user's surrounding type is able to be inferred in real time. Here, a ‘surrounding type’ of a user indicates information about where the user is located. A user's surrounding type may include a bus, a subway and other environments (such as, inside of a building and a market). In addition, a time-series probability model used for audio classification may include HMM, GMM, DBN, MRF and CRF, which are the same as those used for accelerometer classification.

In addition, with regard to the operation for user context recognition 150, a final user context is recognized based on the user' movement type and surrounding type. According to an exemplary embodiment of the present invention, a user context may be recognized based on both the movement type and the surrounding type. According to another exemplary embodiment of the present invention, a user context may be recognized based on either the movement type or the surrounding type. That is, in the case when a user context is able to be recognized based on data collected from a single sensor, it is not necessary to collect data from another sensor. For example, if a user context is recognized based on a user's movement type that is inferred in the operation for accelerometer classification 110, the operation for audio classification 130 is not necessarily performed. Here, a ‘user context’ indicates a user's current state including the user's ‘activities’.

In addition, in the operation for validity check 170, validity of the user context is recognized in the operation for user context recognition 150 is checked based on data collected from a GPS module or a WiFi module, thereby enhancing accuracy in recognizing the user context

According to an exemplary embodiment of the present invention, if the recognized user context is an ambulatory activity (such as, being still, walking and running), a GPS module activates to collect data and a user's speed information is acquired based on the collected data. Then, whether a user's movement type is still, walking or running is determined based on the user's speed information. In this way, validity of the recognized user context may be checked.

According to another exemplary embodiment of the present invention, if the recognized user context is a transportation activity (such as, a bus and a subway), a GPS module activates to collect data and a user's location information is acquired based on the collected data. Next, if a value indicating the user's last location is equivalent to a previously-stored value representing a subway station, it is determined that the user's surrounding type is a subway. In this way, validity of the user context may be checked.

According to another exemplary embodiment of the present invention, if the recognized user context is a transportation activity (such as, a bus and a subway), a WiFi module activates to collect data, and WiFi access information is acquired based on the collected data. If a pattern of repetitively accessing and disconnecting numerous private wireless networks is found in the WiFi access information, it is determined that a user's surrounding type is a bus. Alternatively, if a value indicating a user's last location is equivalent to a previously-stored value indicating a subway station, it is determined that the user's surrounding type is a subway. In this way, validity of the recognized user context may be checked.

Next, if it is determined that the user context is valid according to a result of the validity check, the operation for user context recognition is terminated, whereas, if it is determined that is the user context is invalid according to a result of the validity check, the operations for accelerometer classification and audio classification need to be performed again to recognize a user context in 190. If it is determined that a recognized user context is valid according to a result of the validity check, the recognized user context may be displayed using a user interface before the operation for user context recognition is terminated. Here, the user interface visualizes user context recognized in the operation for user context recognition. The user interface may be a user interface commonly used in a smart phone and other mobile devices in which an apparatus for recognizing a user context is provided.

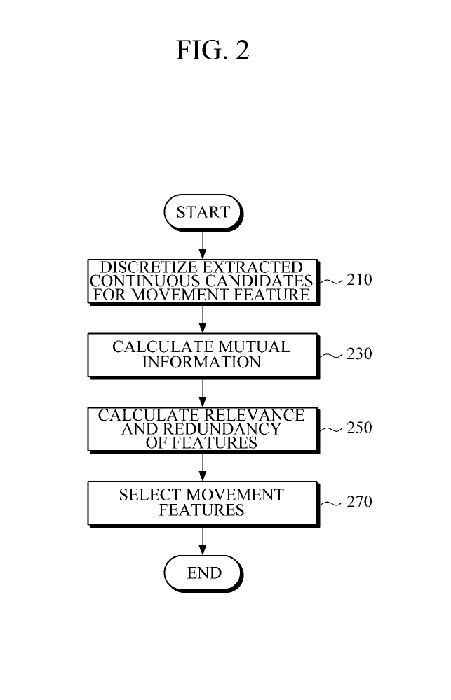

FIG. 2 is a flow chart illustrating a method for recognizing a user context according to an exemplary embodiment of the present invention.

Basically, it is possible to select a considerable number of features from source data. However, features to be used in accelerometer classification needs to be as less as possible in consideration of efficiency in calculation and memory. Conventional feature selection methods include Sequential Forward Selection (SFS), Sequential Backward Selection (SBS) and Sequential Floating Forward Selection (SFFS). However, the present invention employs a unique feature selection method in the operation for acceleration classification so as to select superior features from those extracted from collected accelerometer data, so that unnecessary calculation may be avoided and importance of each feature may be counted when selecting features.

Referring to FIG. 2, the feature selection method of the present invention starts out by discretizing extracted continuous candidates for movement feature in 210. In this case, the extracted continuous candidates for movement feature may be quantized. For example, continuous movement features may be quantized to 8-bit, 16-bit or 32-bit features, but aspects of the present invention is not limited thereto. The quantization is required for sampling analogue data, such as accelerometer data and audio data, at a predetermined number of bits. In addition, a user may discretize the extracted continuous movement features by adjusting the number of bits to be sampled. The following algorithm may be a feature quantization algorithm.

TABLE 1
Algorithm 1: Feature Quantization.

Input: M - Total number of features,.X (1.M) − Training data.Δ − The
quantization error
Output: N - Number of quantization levels, Y (1.M) − Quantized data

| | |
|---|---|
| 1: | Quantization |
| 2: | N = 2; |
| 3: | while 1 do |

| | |
|---|---|
| 4: | MaxError= −1e+16; |
| 5: | for m=1 to M do |

| | |
|---|---|
| 6: | Upper = max(X(nt)); |
| 7: | Lower = min(X(m)); |
| 8: | Step = (Upper − Lower) / N; |
| 9: | Partition = [Lower : Step: Upper]; |
| 10: | CodeBook = [Lower − Step,Lower : Step: Upper]; |
| 11: | [Y(m), QError] = Quantiz(X(m), Partition, |
| | CodeBook); |
| 12: | if QError > MaxError then |

| | |
|---|---|
| 13: | MaxError = QError; |

| | |
|---|---|
| 14: | end if |

| | |
|---|---|
| 15: | end for |
| 16: | if MaxError < Δ then |

| | |
|---|---|
| 17: | break; |

| | |
|---|---|
| 18: | end if |
| 19: | N = N + 1; |

| | |
|---|---|
| 20: | end while |
| 21. | end Quantization |

Next, mutual information is calculated using discrete candidates for movement feature in 230. Here, the mutual information is calculated to be properly utilized in the user context recognition. Mutual information is a quantity that measures the mutual dependence of two random variables, and is used a criterion for feature selection. Specifically, the mutual information is necessary to calculate relevance and redundancy of features.

For example, if two random discrete feature variables X and Y are given, mutual information of X and Y may be calculated according to Equation 1:

$$I ( X ; Y ) = {\sum }_{x ∈ {Ω}_{x}} {\sum }_{y ∈ {Ω}_{y}} p ( x , y ) {log}_{2} ( \frac{p ( x , y )}{p ( x ) p ( y )} ) \qquad [ Equation 1 ]$$

where Ωₓ and Ω_{y} are the state space of X and Y, respectively; p(x,y) is the joint probability distribution function between X and Y; and p(x) and p(y) are the marginal probability distribution functions of X and Y, respectively. If base is not predetermined in Equation 1, the logarithmic function may be uncertain. For example, b indicates base in Equation 1. In addition, the most common unit of measurement of mutual information is the bit, when the base 2 are used.

Next, relevance and redundancy of the features are calculated using the computed mutual information in 250.

The relevance of the features may be represented by class-feature mutual information, which can be calculated according to Equation 2:

$$Rel ( X ) = \frac{I ( C ; X )}{{log}_{2} ( \vert {Ω}_{C} \vert )} \qquad [ Equation 2 ]$$

where X is a feature valuable, C is a class variable, and Ω_{c} is the state space of C. In addition, I(C;X) is the mutual information between C and X, which can be calculated according to Equation 1.

The redundancy of the features may be represented by feature-feature mutual information, which can be calculated according to Equation 3:

$$Red ( X , Y ) = \frac{I ( X ; Y )}{{log}_{2} ( \vert {Ω}_{X} \vert )} \qquad [ Equation 3 ]$$

where X and Y are feature variables and Ωₓ is the state space of X. In addition, I(X;Y) represents mutual information between X and Y, which can be calculated by Equation 1.

Next, features are selected using the computed relevance and redundancy of the features in 270. The selection of features may be gradually extended using a greedy forwarding searching mechanism, but aspects of the present invention is not limited thereto. The above processes may be performed repetitively until the number of selected features reaches to a number which a user wishes. The greedy forwarding searching mechanism may be illustrated in Table 2.

TABLE 2
Algorithm 2: Greedy Forward Searching for Feature Selection.

Input: M - Total number of features, N - Total number of data samples,
K - Number of features to be selected;
X - Training data matrix (M×N), C - Class labels (1×N)
Output: S - The index vector of the selected features (1×K)

| | |
|---|---|
| 1: | Forward |
| 2: | S = Φ; |
| 3: | for m=1 to M do |

| | |
|---|---|
| 4: | Xₘ = Xₘ − μ(Xₘ); |
| 5: | Xₘ = Xₘ / σ(Xₘ); |

| | |
|---|---|
| 6: | end for |
| 7: | X = Quantiz(X); |
| 8: | for k = 1 to K do |

| | |
|---|---|
| 9: | BestScore = −1e+16; |
| 10: | BestIndex = 0, |
| 11: | for i = 1 to M do |

| | |
|---|---|
| 12: | if Xᵢ not in S then |

| | |
|---|---|
| 13: | f = 0, c = 0; |
| 14: | for Xⱼ in S do |

| | |
|---|---|
| 15: | c = c + 1; f = f + Red(Xᵢ, Xⱼ); |

| | |
|---|---|
| 16: | end for |
| 17: | f = Rel(Xᵢ) − f / c; |
| 18: | if (f > BestScore) then |

| | |
|---|---|
| 19: | BestScore = f, |
| 20: | BestIndex = l, |

| | |
|---|---|
| 21: | end if |

| | |
|---|---|
| 22: | end if |

| | |
|---|---|
| 23: | end for |
| 24: | S = {S, BestIndex}; |

| | |
|---|---|
| 25: | end for |
| 26: | end Forward |

The present invention is able to recognize various user contexts with great accuracy using data collected from multimodal sensors.

In addition the present invention is more efficient in terms of calculation and memory than a conventional method, by employing a new feature selection method. The new feature selection method is selecting superior features out of extracted features and then classifying collected data based on the selected features.

Furthermore, validity of a recognized user context is checked using data collected from another sensor, thereby enhancing great accuracy in recognizing the user context.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for recognizing a user context using multimodal sensors, the method comprising:
classifying accelerometer data by extracting candidates for movement feature from the accelerometer data collected from an accelerometer, selecting one or more movement features from the extracted candidates for movement feature based on relevance and redundancy thereof, and then inferring a user's movement type based on the selected movement features using a first time-series probability model;
classifying audio data by extracting surrounding features from the audio data collected from an audio sensor and inferring the user's surrounding type based on the extracted surrounding features; and
recognizing a user context by recognizing the user context based on either of the movement type or the surrounding type.

2. The method of claim 1, wherein each of the accelerometer and the audio sensor activates only in a predetermined condition to collect the accelerometer data and the audio data, respectively.

3. The method of claim 1, wherein the relevance and redundancy of the candidates for movement feature are calculated by Equation 1 (E-1) and Equation 2 (E-2), respectively:
$$\begin{matrix}Rel ( X ) = \frac{I ( C ; X )}{{log}_{2} ( \vert {Ω}_{C} \vert )} & ( E \text{-} 1 ) \\ Red ( X , Y ) = \frac{I ( X ; Y )}{{log}_{2} ( \vert {Ω}_{X} \vert )} & ( E \text{-} 2 )\end{matrix}$$
where X and Y are feature variables; C is a class variable; Ω_{c} is a state space of C; I(C:X) is mutual information between C and X; Ωₓ is a state space of X; and I(X:Y) is mutual information between X and Y.

4. The method of claim 3, wherein the classifying of the accelerometer data comprises gradually extending selection of the movement features using a greedy forwarding searching mechanism.

5. The method of claim 1, wherein the first time-series probability model is Gaussian Mixture Model (GMM), and the second time-series probability model is Hidden Markov model (HMM).

6. The method of claim 1, further comprising:
is acquiring the user's movement speed information and location information from data collected from a GPS module and then checking validity of the recognized user context based on the movement speed information and the location information.

7. The method of claim 1, further comprising
acquiring WiFi access information from data collected from a WiFi module and then checking validity of the recognized user context based on the WiFi access information.
